(19) United States
(12) Patent Application Publication
(10) Pub. No.: US 2019/0188478 A1
(43) Pub. Date: Jun. 20, 2019

(54) METHOD AND APPARATUS FOR OBTAINING VIDEO PUBLIC OPINIONS, COMPUTER DEVICE AND STORAGE MEDIUM

(71) Applicant: BAIDU ONLINE NETWORK TECHNOLOGY (BEIJING) CO., LTD., Beijing (CN)

(72) Inventors: Licen Liu, Beijing (CN); Lu Wang, Beijing (CN); Ting Wei, Beijing (CN); Zecheng Zhuo, Beijing (CN); Xiaocong Zhang, Beijing (CN); Weijia Wu, Beijing (CN)

(73) Assignee: BAIDU ONLINE NETWORK TECHNOLOGY (BEIJING) CO., LTD., Beijing (CN)

(21) Appl. No.: 16/224,234

(22) Filed: Dec. 18, 2018

(30) Foreign Application Priority Data
Dec. 19, 2017 (CN) 2017113742821

(51) Int. Cl. G06K 9/00; G06K 9/62; G10L 15/22; G10L 15/26; G06F 16/71; G06F 16/78; G06F 16/783

(52) U.S. Cl. CPC G06K 9/00711; G06K 9/00362; G06K 9/6201; G10L 15/22; G10L 15/265; G06K 9/00221; G06F 16/7867; G06F 16/7844; G06K 2209/01; G06K 2209/25; G06F 16/71

(57) ABSTRACT

The present disclosure provides a method and apparatus for obtaining video public opinions, a computer device and a storage medium, wherein the method comprises: obtaining an information source and a monitored entity; obtaining real-time stream data from the information source; for each video in the real-time stream data, performing predetermined content recognition respectively for the video to obtain a recognition result; determining whether the video matches with the monitored entity according to the recognition result, and generating and storing public opinion information corresponding to the video if the video matches with the monitored entity. The solution of the present disclosure can be employed to obtain video-like public opinion information.

The present application claims the priority of Chinese Patent Application No. 201711374282.1, filed on Dec. 19, 2017, with the title of “Method and Apparatus for Obtaining Video Public Opinions, Computer Device and Storage Medium”. The disclosure of the above application is incorporated herein by reference in its entirety.

### FIELD OF THE DISCLOSURE

The present disclosure relates to computer application technologies, and particularly to a method and apparatus for obtaining video public opinions, a computer device and a storage medium.

### BACKGROUND OF THE DISCLOSURE

A current public opinion monitoring system mainly collects text-like public opinion information from various media websites, social platforms and mobile terminals. But with the development of technology, more and more public opinion information is published and disseminated in the form of rich media, such as videos.

The existing public opinion acquisition tools are traditional text public opinion tools, and there is no effective solution to how to obtain video public opinions in the prior art.

### SUMMARY OF THE DISCLOSURE

In view of the above, the present disclosure provides a method and apparatus for obtaining video public opinions, a computer device and a storage medium

Specific technical solutions are as follows:

A method for obtaining video public opinions, comprising:

obtaining an information source and a monitored entity;

obtaining real-time stream data from the information source;

for each video in the real-time stream data, performing predetermined content recognition respectively for the video to obtain a recognition result;

determining whether the video matches with the monitored entity according to the recognition result, and generating and storing public opinion information corresponding to the video if the video matches with the monitored entity.

According to a preferred embodiment of the present disclosure, before obtaining real-time stream data from the information source, the method further comprises: obtaining description information of the monitored entity;

the determining whether the video matches with the monitored entity according to the recognition result comprises:

determining whether the video matches the monitored entity by comparing the recognition result and the description information of the monitored entity.

According to a preferred embodiment of the present disclosure, the description information of the monitored entity comprises: a keyword for describing the monitored entity and a picture for describing the monitored entity;

the performing predetermined content recognition for the video comprises: performing text information recognition and person image information recognition for the video;

the determining whether the video matches the monitored entity by comparing the recognition result and the description information of the monitored entity comprises:

determining that the video matches the monitored entity if the text information is recognized and the recognized text information comprises a keyword for describing the monitored entity, or person image information is recognized and the recognized person image comprises a person image in the picture for describing the monitored entity;

or, determining that the video matches the monitored entity if the text information is recognized and the recognized text information comprises a keyword for describing the monitored entity, and the person image information is recognized and the recognized person image comprises a person image in the picture for describing the monitored entity.

According to a preferred embodiment of the present disclosure, the performing predetermined content recognition for the video comprises: performing text information recognition and logo information recognition for the video;

the determining whether the video matches the monitored entity by comparing the recognition result and the description information of the monitored entity comprises:

determining that the video matches the monitored entity if the text information is recognized and the recognized text information comprises a keyword for describing the monitored entity, or logo information is recognized and the recognized logo comprises a logo in the picture for describing the monitored entity;

or, determining that the video matches the monitored entity if the text information is recognized and the recognized text information comprises a keyword for describing the monitored entity, and logo information is recognized and the recognized logo comprises a logo in the picture for describing the monitored entity.

According to a preferred embodiment of the present disclosure, the performing person image information recognition for the video comprises: performing person image information recognition for each frame of picture in the video;

the performing log information recognition for the video comprises: performing logo information recognition for each frame of picture in the video;

the performing text information recognition for the video comprises: respectively recognizing text information existing in each frame of picture in the video.

According to a preferred embodiment of the present disclosure, text information existing in the picture comprises: caption and barrage.

According to a preferred embodiment of the present disclosure, the performing text information recognition for the video comprises: recognizing audio information in the video into text information.

According to a preferred embodiment of the present disclosure, before generating and storing the public opinion information corresponding to the video, the method further comprises:

determining whether the public opinion information corresponding to the video is already stored;

if yes, merging the public opinion information corresponding to the video with the already-stored public opinion information;

if no, generating and storing the public opinion information corresponding to the video.

According to a preferred embodiment of the present disclosure, the generating and storing the public opinion information corresponding to the video comprises: generating and storing the public opinion information corresponding to the video according to a predetermined information structuring format.

An apparatus for obtaining video public opinions, comprising: a first obtaining unit, a second obtaining unit, a recognizing unit, a matching unit and a storing unit;

the first obtaining unit is configured to obtain an information source and a monitored entity;

the second obtaining unit is configured to obtain real-time stream data from the information source;

the recognizing unit is configured to, for each video in the real-time stream data, perform predetermined content recognition respectively for the video to obtain a recognition result;

the matching unit is configured to determine whether the video matches with the monitored entity according to the recognition result;

the storing unit is configured to generate and store public opinion information corresponding to the video when the video matches with the monitored entity.

According to a preferred embodiment of the present disclosure, the first obtaining unit is further configured to obtain description information of the monitored entity;

the matching unit determines whether the video matches the monitored entity by comparing the recognition result and the description information of the monitored entity.

According to a preferred embodiment of the present disclosure, the description information of the monitored entity comprises a keyword for describing the monitored entity and a picture for describing the monitored entity;

the recognizing unit performs text information recognition and person image information recognition for the video;

the matching unit determines that the text information is recognized and the recognized text information comprises a keyword for describing the monitored entity, or person image information is recognized and the recognized person image comprises a person image in the picture for describing the monitored entity, and then determines that the video matches the monitored entity;

or, the matching unit determines that the text information is recognized and the recognized text information comprises a keyword for describing the monitored entity, and the person image information is recognized and the recognized person image comprises a person image in the picture for describing the monitored entity, and then determines that the image matches the monitored entity.

According to a preferred embodiment of the present disclosure, the recognizing unit performs text information recognition and logo information recognition for the video;

the matching unit determines that the text information is recognized and the recognized text information comprises a keyword for describing the monitored entity, or logo information is recognized and the recognized logo comprises a logo in the picture for describing the monitored entity, and then determines that the video matches the monitored entity;

or, the matching unit determines that the text information is recognized and the recognized text information comprises a keyword for describing the monitored entity, and logo information is recognized and the recognized logo comprises a logo in the picture for describing the monitored entity, and then determines that the video matches the monitored entity.

According to a preferred embodiment of the present disclosure, the recognizing unit performs person image information recognition for each frame of picture in the video;

the recognizing unit performs logo information recognition for each frame of picture in the video;

the recognizing unit respectively recognizes text information existing in each frame of picture in the video.

According to a preferred embodiment of the present disclosure, text information existing in the picture comprises: caption and barrage.

According to a preferred embodiment of the present disclosure, the recognizing unit is further configured to recognize audio information in the video into text information.

According to a preferred embodiment of the present disclosure, the storing unit is further configured to, before generating and storing the public opinion information corresponding to the video, determine whether the public opinion information corresponding to the video is already stored, and if yes, merge the public opinion information corresponding to the video with the already-stored public opinion information, or if no, generate and store the public opinion information corresponding to the video.

According to a preferred embodiment of the present disclosure, the storing unit generates and stores the public opinion information corresponding to the video according to a predetermined information structuring format.

A computer device, comprising a memory, a processor and a computer program which is stored on the memory and runs on the processor, the processor, upon executing the program, implementing the above-mentioned method.

A computer-readable storage medium on which a computer program is stored, the program, when executed by the processor, implementing the aforesaid method.

As can be seen from the above introduction, the solutions of the present disclosure may be employed to first obtain an information source and a monitored entity; obtain real-time stream data from the information source; for each video in the real-time stream data, perform predetermined content recognition respectively for the video to obtain a recognition result; then determine whether the video matches with the monitored entity according to the recognition result, and if yes, generate and store the public opinion information corresponding to the video, thereby implementing acquisition of the video-like public opinion information, and making up for the drawback in the prior art that the video-like public opinion scene is not covered.

### BRIEF DESCRIPTION OF DRAWINGS

FIG. 1 is a flowchart of an embodiment of a method for obtaining video public opinions according to the present disclosure.

FIG. 2 is a schematic diagram of an overall implementation process of a method for obtaining video public opinions according to the present disclosure.

FIG. 3 is a schematic structural diagram of an embodiment of an apparatus for obtaining video public opinions according to the present disclosure.

FIG. 4 illustrates a block diagram of an example computer system/server 12 adapted to implement an implementation mode of the present disclosure.

### DETAILED DESCRIPTION OF PREFERRED EMBODIMENTS

Technical solutions of the present disclosure will be described in more detail in conjunction with figures and embodiments to make technical solutions of the present disclosure clear and more apparent.

Obviously, the described embodiments are partial embodiments of the present disclosure, not all embodiments. Based on embodiments in the present disclosure, all other embodiments obtained by those having ordinary skill in the art without making inventive efforts all fall within the protection scope of the present disclosure.

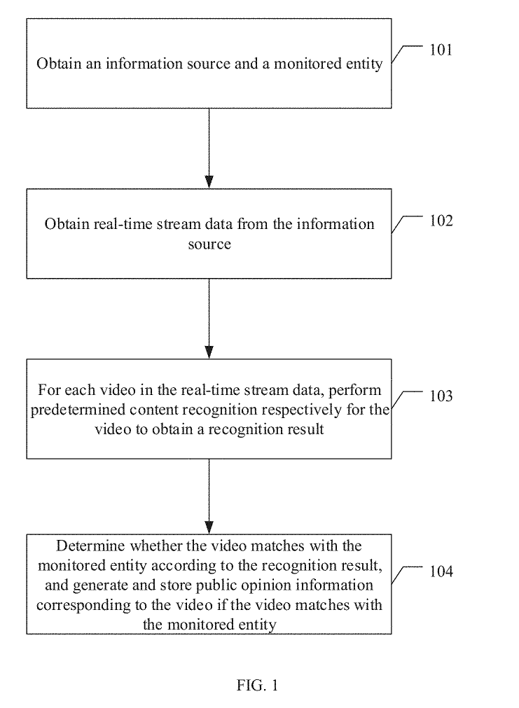

FIG. 1 is a flowchart of an embodiment of a method for obtaining video public opinions according to the present disclosure. As shown in FIG. 1, the embodiment comprises the following specific implementation mode.

In 101, obtain an information source and a monitored entity.

In 102, obtain real-time stream data from the information source.

In 103, for each video in the real-time stream data, perform predetermined content recognition respectively for the video to obtain a recognition result.

In 104, determine whether the video matches with the monitored entity according to the recognition result, and generate and store the public opinion information corresponding to the video if the video matches with the monitored entity.

In the present embodiment, it is necessary to first obtain the information source and the monitored entity.

The information source refers to from where the information is obtained. The information source may be manually defined according to actual needs, for example, microblog, posting bar, forum, sews site, etc.

In addition, it is further possible to define one or more monitored entities, and meanwhile define description information of the monitored entities. The description information of the monitored entity may comprise a keyword for describing the monitored entity and a picture for describing the monitored entity.

For example, if the monitored entity is a person, the keyword for describing the monitored entity may refer to the person's name or position, and the picture for describing the monitored entity may refer to a person image video of the person, and the person image video usually refers to a video of the person's face.

For another example, if the monitored entity is a certain brand, the keyword for describing the monitored entity may refer to the Chinese name of the brand, etc., and the picture for describing the monitored entity may refer to a logo video of the brand.

It is possible to obtain real-time stream data from information sources, i.e., have an access to real-time stream data of each information source. For example, the real-time stream data comprise real-time stream data of microblogs, real-time stream data of posting bars, and real-time stream data of news sites.

After obtaining the real-time stream data, it is possible to first filter out garbage from the real-time stream data, that is, filter out contents such as advertisements and pornography. After that, it is possible to perform predetermined content recognition for each piece in the real-time stream data from which garbage is already filtered out, to obtain a recognition result, and determine whether the video matches the monitored entity according to the recognition result, and if matching, generate and store the public opinion information corresponding to the video.

The performing predetermined content recognition for the video may comprise: performing text information recognition and person image information recognition for the video, performing text information recognition and logo information recognition for the video, and so on.

It is possible to, after obtaining the recognition result of the video, compare the comparison result with the description information of the monitored entity to determine whether the video matches the monitored entity.

For example, if the text information is recognized and the recognized text information comprises a keyword for describing the monitored entity, or the person image information is recognized and the recognized person image comprises a person image in the picture for describing the monitored entity, determination is made as to whether the video matches the monitored entity.

Alternatively, if the text information is recognized and the recognized text information comprises a keyword for describing the monitored entity, and the person image information is recognized and the recognized person image comprises a person image in the picture for describing the monitored entity, determination is made as to whether the video matches the monitored entity.

For another example, if the text information is recognized and the recognized text information comprises a keyword for describing the monitored entity, or logo information is recognized and the recognized logo comprises a logo in the picture for describing the monitored entity, determination is made as to whether the video matches the monitored entity.

Alternatively, if the text information is recognized and the recognized text information comprises a keyword for describing the monitored entity, and the logo information is recognized and the recognized logo comprises a logo in the picture for describing the monitored entity, determination is made as to whether the video matches the monitored entity.

It is possible to perform person image information recognition for each frame of picture in the video. The person image information of the video may be recognized by using a technology such as human face detection in the prior art.

It is possible to perform logo information recognition for each frame of picture in the video. The logo information in the picture may be recognized by using a sift operator to recognize with a technology such as trademark image search in the prior art.

In addition, it is possible to recognize text information existing in each frame of picture in the video. For example, the text information may comprise: caption, barrage and so on. In addition, audio information in the video may be recognized as text information.

It is possible to recognize caption and barrage in the picture in a conventional manner such as Optical Character Recognition (OCR). In addition, if a caption file can be separated from the video file, words content in the caption file can be recognized after the separation.

If an audio file can be separated from the video file, words content in the audio file can be recognized after the separation. If the audio file cannot be separated from the video file, words content may be recognized through a speech recognition technology.

In practical applications, the number of person images or logos in the picture for describing the monitored entity is usually one, and the number of recognized person images or logos may be one or more than one.

In addition, the number of keywords for describing the monitored entity may be one or multiple. If there are multiple keywords, when determining whether the video matches the monitored entity, it is possible to require the recognized text information to comprise any one or more keywords for describing the monitored entity, or require the recognized text information to comprise all keywords for describing the monitored entity.

Assuming that the monitored entity is a person, it is possible to perform person image recognition and text information recognition respectively for the video in the real-time stream data. If the person image information and the text information can be recognized, it is possible to further determine whether the recognized person image comprises the person image in the picture for describing the monitored entity and whether the recognized text information comprises a keyword for describing the monitored entity. If the two conditions are both met, it is possible to judge that the video matches the monitored entity, or if one condition is met, it is possible to judge that the video matches the monitored entity.

Assuming that the monitored entity is a certain brand, it is possible to perform logo recognition and text information recognition respectively for the video in the real-time stream data. If the logo information and the text information can be recognized, it is possible to further determine whether the recognized logo comprises a logo in the picture for describing the monitored entity and whether the recognized text information comprises a keyword for describing the monitored entity. If the two conditions are both met, it is possible to judge that the video matches the monitored entity, or if one condition is met, it is possible to judge that the video matches the monitored entity.

If the video matches the monitored entity, it is possible to further generate and store the public opinion information corresponding to the video.

Preferably, it is possible to first determine whether the public opinion information corresponding to the video has already been stored, and if so, merge the public opinion information corresponding to the video with the already-stored public opinion information, or if no, generate and store the public opinion information corresponding to the video. Specifically, it is possible to generate and store the public opinion information corresponding to the video in a predetermined information structuring format.

The information structuring format may be as follows.

Assume that a microblog information published by a user comprises a video, and the video matches the monitored entity, the public opinion information corresponding to the video may comprise: release time, number of user attention, number of user fans, user name, Uniform Resource Locator (URL) of the head image, the content of this post, the number of microblogs posted by the user of this post, whether the user of this post is authenticated, url of this post, times of forwarding this post, the number of comments on this post, the number of likes posted for this post, the url of the matched video, type of video match (words, character (person image), logo, or the like), emotion orientation, character or logo coordinates, information type (goods release, daily life photo, complaint, abuse, etc.), on which frame(s) the matching is successfully performed, and so on.

Suppose a piece of WeChat information published by a certain WeChat public account comprises a video, and the video matches the monitored entity, the public opinion information corresponding to the video may comprise: full text, title, url, release time, number of likes, number of readings, the number of comments, the name of the public account, a home page of the public account, the matched video url, the type of video match, the emotion orientation, the character or logo coordinates, the type of information, on which frame(s) the matching is successfully performed, and so on.

Suppose a piece of information published by Toutiao comprises a video, and the video matches the monitored entity, the public opinion information corresponding to the video may comprise: full text, title, url, release time, number of praises, number of likes, number of comments, the name of Toutiao, number of attentions to Toutiao, number of fans of Toutiao, the matched video url, type of video match, emotion orientation, character or logo coordinates, information type, on which frame(s) the matching is successfully performed, and so on.

Suppose a piece of information in a post bar comprises a video, and the video matches the monitored entity, the public opinion information corresponding to the video may comprise: title, creation time, user name, content of a main post, content of reply posts, and number of reply posts, the matched video url, type of image matching, emotion orientation, character or logo coordinates, information type, on which frame(s) the matching is successfully performed, and so on.

Suppose a piece of information in a forum/community comprises a video, and the video matches the monitored entity, the public opinion information corresponding to the video may comprise: title, full text, number of comments, number of likes, user name, the matched video url, type of image match, emotion orientation, head image or logo coordinates, information type, on which frame(s) the matching is successfully performed, and so on.

Suppose a news item published by a certain news site comprises a video, and the video matches the monitored entity, the public opinion information corresponding to the video may comprise: title, full text, release time, news source, number of readings, number of comments, number of posted likes, the matched video url, the type of image match, emotion orientation, character or logo coordinates, on which frame(s) the matching is successfully performed, and so on.

It should be appreciated that the information structuring formats described above are only for exemplary illustration and are not intended to limit the technical solution of the present disclosure, and specific contents included may depend on actual needs and are not limited to what are stated above.

In practical application, if the public opinion information corresponding to the video might be already stored for various reasons, it is possible to merge the public opinion information corresponding to the video with the already-stored public opinion information.

For example, different news sites publish the same news, but the publication time is different. Additionally, the video included in the news matches the monitored entity. When the video in the news published later is processed, it will be found that the public opinion information corresponding to the video is already stored, and correspondingly, the merging process can be performed. In addition, if a certain user posts a piece of microblog information, other users forward the information, and the video included in the microblog information matches the monitored entity, the public opinion information corresponding to “forward” and “be forwarded” may be merged. How to merge is not limited so long as the above relationship can be reflected.

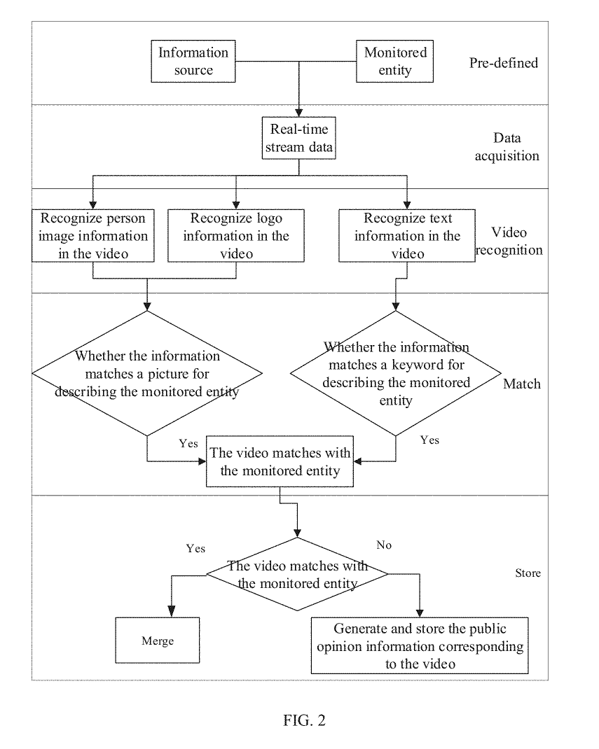

Based on the above description, FIG. 2 is a schematic diagram of an overall implementation process of the video public opinion acquisition method according to the present disclosure. As shown in FIG. 2, it is possible to first obtain a defined information source and a monitored entity; then, obtain real-time stream data from the information source; for each video in the real-time stream data, perform text information recognition and person image information or logo information recognition respectively; determine whether the recognized text information comprises a keyword for describing the monitored entity and whether the recognized person image or logo comprises a person image or logo in the picture for describing the monitored entity, that is, determine whether the recognized text information matches with the keyword for describing the monitored entity and whether the recognized person image or logo matches the picture for describing the monitored entity, and if yes, determine that the video matches the monitored entity; further determine whether the public opinion information corresponding to the video is already stored, and if yes, merge the public opinion information corresponding to the video with the stored public opinion information, otherwise, generate and store the public opinion information corresponding to the video according to the predetermined information structuring format

In summary, the solution described in the above method embodiment may be used to implement the acquisition of video-like public opinion information, make up for the drawback in the prior art that the video-like public opinion scene is not covered, and thereby comprehensively and accurately obtain various forms of netizen public opinion.

The above is an introduction to the method embodiment, and the solution of the present disclosure will be further described below by means of an apparatus embodiment.

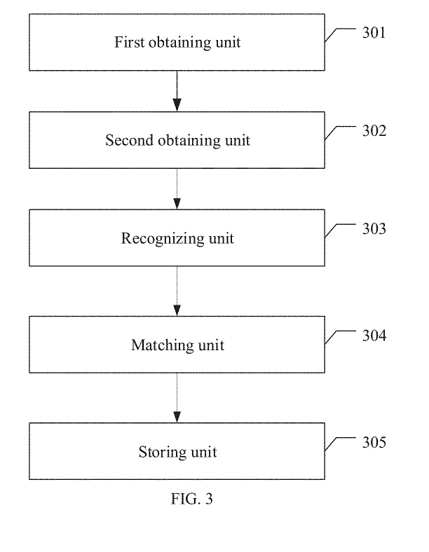

FIG. 3 is a schematic structural diagram of an embodiment of an apparatus for obtaining video public opinions according to the present disclosure. As shown in FIG. 3, the apparatus comprises: a first obtaining unit 301, a second obtaining unit 302, a recognizing unit 303, a matching unit 304 and a storing unit 305.

The first obtaining unit 301 is configured to obtain an information source and a monitored entity.

The second obtaining unit 302 is configured to obtain real-time stream data from the information source.

The recognizing unit 303 is configured to, for each video in the real-time stream data, perform predetermined content recognition for the video to obtain a recognition result.

The matching unit 304 is configured to determine whether the video matches with the monitored entity according to the recognition result.

The storing unit 305 is configured to generate and store public opinion information corresponding to the video when the video matches with the monitored entity.

The first obtaining unit 301 may obtain the defined information source and monitored entity, and further obtain description information of the monitored entity. The description information of the monitored entity may comprise a keyword for describing the monitored entity and a picture for describing the monitored entity.

Correspondingly, the second obtaining unit 302 may obtain real-time stream data from information sources, i.e., have an access to real-time stream data of each information source. For example, the real-time stream data may comprise real-time stream data of microblogs, real-time stream data of posting bars, and real-time stream data of news sites.

The recognizing unit 303 may, for each video in the real-time stream data, perform predetermined content recognition respectively for the video to obtain a recognition result.

Then, the matching unit 304 may determine whether the video matches the monitored entity by comparing the recognition result and the description information of the monitored entity.

The recognizing unit 303 may perform text information recognition and person image information recognition for the video.

Correspondingly, the matching unit 304 determines that the text information is recognized and the recognized text information comprises a keyword for describing the monitored entity, or person image information is recognized and the recognized person image comprises a person image in the picture for describing the monitored entity, and then determines that the video matches the monitored entity.

Alternatively, the matching unit 304 determines that the text information is recognized and the recognized text information comprises a keyword for describing the monitored entity, and the person image information is recognized and the recognized person image comprises a person image in the picture for describing the monitored entity, and then determines that the image matches the monitored entity.

The recognizing unit 303 may further perform text information recognition and logo information recognition for the video.

Correspondingly, the matching unit 304 determines that the text information is recognized and the recognized text information comprises a keyword for describing the monitored entity, or logo information is recognized and the recognized logo comprises a logo in the picture for describing the monitored entity, and then determines that the video matches the monitored entity.

Alternatively, the matching unit 304 determines that the text information is recognized and the recognized text information comprises a keyword for describing the monitored entity, and logo information is recognized and the recognized logo comprises a logo in the picture for describing the monitored entity, and then determines that the video matches the monitored entity.

The recognizing unit 303 performs person image information recognition for each frame of picture in the video, and performs logo information recognition for each frame of picture in the video.

In addition, the recognizing unit 303 respectively recognizes text information such as caption and barrage existing in each frame of picture in the video. In addition, the recognizing unit 303 is further configured to recognize audio information in the video into text information.

If the video matches the monitored entity, the storing unit 305 may further generate and store the public opinion information corresponding to the video.

Preferably, before generating and storing the public opinion information corresponding to the video, the storing unit 305 may first determine whether the public opinion information corresponding to the video is already stored, and if yes, merge the public opinion information corresponding to the video with the already-stored public opinion information, or if no, generate and store the public opinion information corresponding to the video. Specifically, the storing unit 305 can generate and store the public opinion information corresponding to the video according to a predetermined information structuring format.

Reference may be made to corresponding depictions in the aforesaid method embodiments for a specific workflow of the apparatus embodiments shown in FIG. 3. The workflow is not detailed any more.

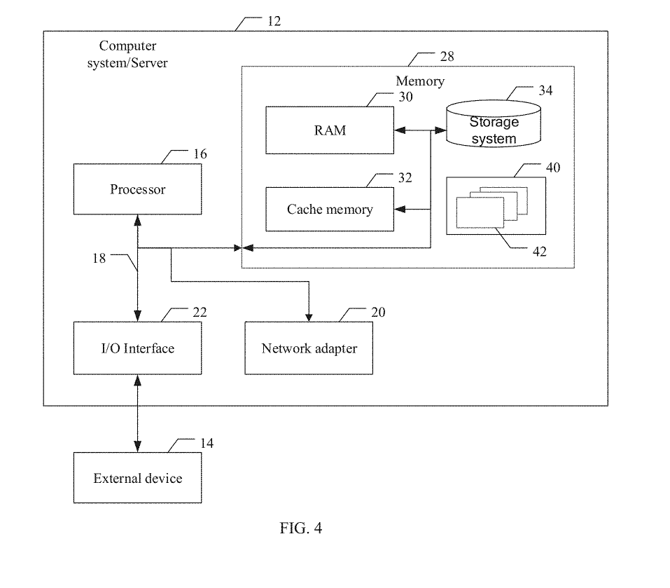

FIG. 4 illustrates a block diagram of an example computer system/server 12 adapted to implement an implementation mode of the present disclosure. The computer system/server 12 shown in FIG. 4 is only an example and should not bring about any limitation to the function and scope of use of the embodiments of the present disclosure.

As shown in FIG. 4, the computer system/server 12 is shown in the form of a general-purpose computing device. The components of computer system/server 12 may comprise, but are not limited to, one or more processors (processing units) 16, a memory 28, and a bus 18 that couples various system components including system memory 28 and the processor 16.

Bus 18 represents one or more of several types of bus structures, including a memory bus or memory controller, a peripheral bus, an accelerated graphics port, and a processor or local bus using any of a variety of bus architectures. By way of example, and not limitation, such architectures comprise Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer system/server 12 typically comprises a variety of computer system readable media. Such media may be any available media that is accessible by computer system/server 12, and it comprises both volatile and non-volatile media, removable and non-removable media.

Memory 28 can comprise computer system readable media in the form of volatile memory, such as random access memory (RAM) 30 and/or cache memory 32. Computer system/server 12 may further comprise other removable/non-removable, volatile/non-volatile computer system storage media. By way of example only, storage system 34 can be provided for reading from and writing to a non-removable, non-volatile magnetic media (not shown in FIG. 4 and typically called a “hard drive”). Although not shown in FIG. 4, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each drive can be connected to bus 18 by one or more data media interfaces. The memory 28 may comprise at least one program product having a set (e.g., at least one) of program modules that are configured to carry out the functions of embodiments of the present disclosure.

Program/utility 40, having a set (at least one) of program modules 42, may be stored in the system memory 28 by way of example, and not limitation, as well as an operating system, one or more disclosure programs, other program modules, and program data. Each of these examples or a certain combination thereof might comprise an implementation of a networking environment. Program modules 42 generally carry out the functions and/or methodologies of embodiments of the present disclosure.

Computer system/server 12 may also communicate with one or more external devices 14 such as a keyboard, a pointing device, a display 24, etc.; with one or more devices that enable a user to interact with computer system/server 12; and/or with any devices (e.g., network card, modem, etc.) that enable computer system/server 12 to communicate with one or more other computing devices. Such communication can occur via Input/Output (I/O) interfaces 22. Still yet, computer system/server 12 can communicate with one or more networks such as a local area network (LAN), a general wide area network (WAN), and/or a public network (e.g., the Internet) via network adapter 20. As depicted in FIG. 4, network adapter 20 communicates with the other communication modules of computer system/server 12 via bus 18. It should be understood that although not shown, other hardware and/or software modules could be used in conjunction with computer system/server 12. Examples, comprise, but are not limited to: microcode, device drivers, redundant processing units, external disk drive arrays, RAID systems, tape drives, and data archival storage systems, etc.

The processor 16 executes various function applications and data processing by running programs stored in the memory 28, for example, implement the method in the embodiment shown in FIG. 1.

The present disclosure meanwhile provides a computer-readable storage medium on which a computer program is stored, the program, when executed by a processor, implementing the method stated in the embodiment shown in FIG. 1.

The computer-readable medium of the present embodiment may employ any combinations of one or more computer-readable media. The machine readable medium may be a machine readable signal medium or a machine readable storage medium. A machine readable medium may comprise, but not limited to, an electronic, magnetic, optical, electromagnetic, infrared, or semiconductor system, apparatus, or device, or any suitable combination of the foregoing. More specific examples of the machine readable storage medium would comprise an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the text herein, the computer readable storage medium can be any tangible medium that comprise or store programs for use by an instruction execution system, apparatus or device or a combination thereof.

The computer-readable signal medium may be included in a baseband or serve as a data signal propagated by part of a carrier, and it carries a computer-readable program code therein. Such propagated data signal may take many forms, including, but not limited to, electromagnetic signal, optical signal or any suitable combinations thereof. The computer-readable signal medium may further be any computer-readable medium besides the computer-readable storage medium, and the computer-readable medium may send, propagate or transmit a program for use by an instruction execution system, apparatus or device or a combination thereof.

The program codes included by the computer-readable medium may be transmitted with any suitable medium, including, but not limited to radio, electric wire, optical cable, RF or the like, or any suitable combination thereof.

Computer program code for carrying out operations disclosed herein may be written in one or more programming languages or any combination thereof. These programming languages comprise an object oriented programming language such as Java, Smalltalk, C++ or the like, and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

In the embodiments provided by the present disclosure, it should be understood that the revealed apparatus and method can be implemented in other ways. For example, the above-described embodiments for the apparatus are only exemplary, e.g., the division of the units is merely logical one, and, in reality, they can be divided in other ways upon implementation.

The units described as separate parts may be or may not be physically separated, the parts shown as units may be or may not be physical units, i.e., they can be located in one place, or distributed in a plurality of network units. One can select some or all the units to achieve the purpose of the embodiment according to the actual needs.

Further, in the embodiments of the present disclosure, functional units can be integrated in one processing unit, or they can be separate physical presences; or two or more units can be integrated in one unit. The integrated unit described above can be implemented in the form of hardware, or they can be implemented with hardware plus software functional units.

The aforementioned integrated unit in the form of software function units may be stored in a computer readable storage medium. The aforementioned software function units are stored in a storage medium, including several instructions to instruct a computer device (a personal computer, server, or network equipment, etc.) or processor to perform some steps of the method described in the various embodiments of the present disclosure. The aforementioned storage medium comprises various media that may store program codes, such as U disk, removable hard disk, Read-Only Memory (ROM), a Random Access Memory (RAM), magnetic disk, or an optical disk.

What are stated above are only preferred embodiments of the present disclosure and not intended to limit the present disclosure. Any modifications, equivalent substitutions and improvements made within the spirit and principle of the present disclosure all should be included in the extent of protection of the present disclosure.

What is claimed is:

1. A method for obtaining video public opinions, wherein the method comprises:
obtaining an information source and a monitored entity;
obtaining real-time stream data from the information source;
for each video in the real-time stream data, performing predetermined content recognition respectively for the video to obtain a recognition result;
determining whether the video matches with the monitored entity according to the recognition result, and generating and storing public opinion information corresponding to the video if the video matches with the monitored entity.

2. The method according to claim 1, wherein
before obtaining real-time stream data from the information source, the method further comprises: obtaining description information of the monitored entity;
the determining whether the video matches with the monitored entity according to the recognition result comprises:
determining whether the video matches the monitored entity by comparing the recognition result and the description information of the monitored entity.

3. The method according to claim 2, wherein
the description information of the monitored entity comprises: a keyword for describing the monitored entity and a picture for describing the monitored entity;
the performing predetermined content recognition for the video comprises: performing text information recognition and person image information recognition for the video;
the determining whether the video matches the monitored entity by comparing the recognition result and the description information of the monitored entity comprises:
determining that the video matches the monitored entity if the text information is recognized and the recognized text information comprises a keyword for describing the monitored entity, or person image information is recognized and the recognized person image comprises a person image in the picture for describing the monitored entity;
or, determining that the video matches the monitored entity if the text information is recognized and the recognized text information comprises a keyword for describing the monitored entity, and the person image information is recognized and the recognized person image comprises a person image in the picture for describing the monitored entity.

4. The method according to claim 3, wherein
the performing predetermined content recognition for the video comprises: performing text information recognition and logo information recognition for the video;
the determining whether the video matches the monitored entity by comparing the recognition result and the description information of the monitored entity comprises:
determining that the video matches the monitored entity if the text information is recognized and the recognized text information comprises a keyword for describing the monitored entity, or logo information is recognized and the recognized logo comprises a logo in the picture for describing the monitored entity;
or, determining that the video matches the monitored entity if the text information is recognized and the recognized text information comprises a keyword for describing the monitored entity, and logo information is recognized and the recognized logo comprises a logo in the picture for describing the monitored entity.

5. The method according to claim 4, wherein
the performing person image information recognition for the video comprises: performing person image information recognition for each frame of picture in the video;
the performing logo information recognition for the video comprises: performing logo information recognition for each frame of picture in the video;
the performing text information recognition for the video comprises: respectively recognizing text information existing in each frame of picture in the video.

6. The method according to claim 5, wherein
text information existing in the picture comprises: caption and barrage.

7. The method according to claim 5, wherein the performing text information recognition for the video comprises: recognizing audio information in the video into text information.

8. The method according to claim 1, wherein
before generating and storing the public opinion information corresponding to the video, the method further comprises:
determining whether the public opinion information corresponding to the video is already stored;
if yes, merging the public opinion information corresponding to the video with the already-stored public opinion information;
if no, generating and storing the public opinion information corresponding to the video.

9. The method according to claim 1, wherein
the generating and storing the public opinion information corresponding to the video comprises:
generating and storing the public opinion information corresponding to the video according to a predetermined information structuring format.

10. A computer device, comprising a memory, a processor and a computer program which is stored on the memory and runs on the processor, wherein the processor, upon executing the program, implements a method for obtaining video public opinions, wherein the method comprises:
obtaining an information source and a monitored entity;
obtaining real-time stream data from the information source;
for each video in the real-time stream data, performing predetermined content recognition respectively for the video to obtain a recognition result;
determining whether the video matches with the monitored entity according to the recognition result, and generating and storing public opinion information corresponding to the video if the video matches with the monitored entity.

11. The computer device according to claim 10, wherein
before obtaining real-time stream data from the information source, the method further comprises: obtaining description information of the monitored entity;
the determining whether the video matches with the monitored entity according to the recognition result comprises:
determining whether the video matches the monitored entity by comparing the recognition result and the description information of the monitored entity.

12. The computer device according to claim 11, wherein
the description information of the monitored entity comprises: a keyword for describing the monitored entity and a picture for describing the monitored entity;
the performing predetermined content recognition for the video comprises: performing text information recognition and person image information recognition for the video;
the determining whether the video matches the monitored entity by comparing the recognition result and the description information of the monitored entity comprises:
determining that the video matches the monitored entity if the text information is recognized and the recognized text information comprises a keyword for describing the monitored entity, or person image information is recognized and the recognized person image comprises a person image in the picture for describing the monitored entity;
or, determining that the video matches the monitored entity if the text information is recognized and the recognized text information comprises a keyword for describing the monitored entity, and the person image information is recognized and the recognized person image comprises a person image in the picture for describing the monitored entity.

13. The computer device according to claim 12, wherein
the performing predetermined content recognition for the video comprises: performing text information recognition and logo information recognition for the video;
the determining whether the video matches the monitored entity by comparing the recognition result and the description information of the monitored entity comprises:
determining that the video matches the monitored entity if the text information is recognized and the recognized text information comprises a keyword for describing the monitored entity, or logo information is recognized and the recognized logo comprises a logo in the picture for describing the monitored entity;
or, determining that the video matches the monitored entity if the text information is recognized and the recognized text information comprises a keyword for describing the monitored entity, and logo information is recognized and the recognized logo comprises a logo in the picture for describing the monitored entity.

14. The computer device according to claim 13, wherein
the performing person image information recognition for the video comprises: performing person image information recognition for each frame of picture in the video;
the performing logo information recognition for the video comprises: performing logo information recognition for each frame of picture in the video;
the performing text information recognition for the video comprises: respectively recognizing text information existing in each frame of picture in the video.

15. The computer device according to claim 14, wherein
text information existing in the picture comprises: caption and barrage.

16. The computer device according to claim 14, wherein the performing text information recognition for the video comprises: recognizing audio information in the video into text information.

17. The computer device according to claim 10, wherein
before generating and storing the public opinion information corresponding to the video, the method further comprises:
determining whether the public opinion information corresponding to the video is already stored;
if yes, merging the public opinion information corresponding to the video with the already-stored public opinion information;
if no, generating and storing the public opinion information corresponding to the video.

18. The computer device according to claim 10, wherein
the generating and storing the public opinion information corresponding to the video comprises:
generating and storing the public opinion information corresponding to the video according to a predetermined information structuring format.

19. A computer-readable storage medium on which a computer program is stored, wherein the program, when executed by a processor, implements a method for obtaining video public opinions, wherein the method comprises:
obtaining an information source and a monitored entity;
obtaining real-time stream data from the information source;
for each video in the real-time stream data, performing predetermined content recognition respectively for the video to obtain a recognition result;
determining whether the video matches with the monitored entity according to the recognition result, and generating and storing public opinion information corresponding to the video if the video matches with the monitored entity.

20. The computer-readable storage medium according to claim 19, wherein
before obtaining real-time stream data from the information source, the method further comprises: obtaining description information of the monitored entity;
the determining whether the video matches with the monitored entity according to the recognition result comprises:
determining whether the video matches the monitored entity by comparing the recognition result and the description information of the monitored entity.
